(19) United States
(12) Patent Application Publication
(10) Pub. No.: US 2024/0343852 A1
(43) Pub. Date: Oct. 17, 2024

(54) RESIN COMPOSITION AND APPLICATION THEREOF

(71) Applicant: HUAWEI TECHNOLOGIES CO., LTD., Shenzhen (CN)

(72) Inventors: Min Chao CHUANG, Shenzhen (CN); Hailiang ZOU, Beijing (CN); Guiyun CHEN, Shenzhen (CN); Tao LIU, Shenzhen (CN)

(21) Appl. No.: 18/757,135

(22) Filed: Jun. 27, 2024

Related U.S. Application Data
(63) Continuation of application No. PCT/CN2022/143867, filed on Dec. 30, 2022.

(30) Foreign Application Priority Data
Dec. 31, 2021 (CN) 202111676523.4

(51) Int. Cl. C08F 290/06; C08F 2/50; C08K 5/37

(52) U.S. Cl. CPC C08F 290/067; C08F 2/50; C08K 5/37; C08F 2810/30

(57) ABSTRACT

Embodiments of this disclosure provide a resin composition and an disclosure thereof. The resin composition includes a polyurethane acrylate and a curing monomer, the curing monomer includes a compound containing a free radical polymerizable group and/or a compound containing a moisture curable group, and a weight-average molecular weight of the curing monomer is greater than or equal to 300.

### CROSS-REFERENCE TO RELATED DISCLOSURES

This application is a continuation of International Application No. PCT/CN2022/143867, filed on Dec. 30, 2022, which claims priority to Chinese Patent Application No. 202111676523.4, filed on Dec. 31, 2021. The disclosures of the aforementioned applications are hereby incorporated by reference in their entireties.

### TECHNICAL FIELD

Embodiments of this disclosure relate to the field of resin composition preparation technologies, and in particular, to a resin composition and an disclosure thereof.

### BACKGROUND

Currently, wearable devices are widely popular in the market. Because most wearable devices are in direct contact with human skin when worn, there may be some human allergy risks. True Wireless Stereo (TWS) Bluetooth headsets are used as an example. As shipments and popularity of the TWS headsets increase, there may be some accidents that users suffer from skin allergies caused by the TWS headsets in the market, and some users even suffer from symptoms such as ear suppuration and scabbing. A main cause of these allergy accidents is that in-ear parts of the headsets contain acrylic ester. The acrylic ester mainly comes from a UV curing adhesive or UV moisture curing adhesive used for assembling and fastening elements of the TWS headset. Basic raw materials of these adhesives include an oligomer, an active monomer, a photoinitiator, and the like. The oligomer has an unsaturated double bond group, and is used as a main bonding material. The active monomer is small in molecular weight and is low in viscosity; not only has good dilutability, but also participates in reaction; and may increase crosslinking of an adhesive. The photoinitiator, as an optical energy absorption carrier, generates active fragments such as free radicals, cations, and anions that can trigger polymerization of the oligomer and the monomer. However, in actual disclosure, some active monomers are usually unable to completely react and cure, and these active monomers are small in molecular weight and are volatile to a specific extent, causing the human allergy risk.

### SUMMARY

In view of this, embodiments of this disclosure provide a resin composition and an disclosure thereof. The resin composition has low Volatile Organic Compound (VOC) content before and after the resin composition is cured, and has good bonding effect. The resin composition may be used as an adhesive in a wearable device such as a headset, to implement reliable fastening and bonding, and resolve a human allergy problem caused by the adhesive in a conventional technology to some extent.

In an embodiment, a first aspect of embodiments of this disclosure provides a resin composition. The resin composition includes a polyurethane acrylate and a curing monomer, the curing monomer includes a compound containing at least one of a free radical polymerizable group or a compound containing a moisture curable group, and a weight-average molecular weight of the curing monomer is greater than or equal to 300.

According to the resin composition provided in the first aspect of embodiment of this disclosure, a curing monomer whose molecular weight is greater than or equal to 300 is selected, so that volatility before and after the resin composition is cured can be reduced, and an allergy risk of the resin composition to human skin can be reduced. Therefore, when the resin composition is used as an adhesive in a device such as a headset, reliable fastening and bonding can be implemented, and a human allergy problem caused by the adhesive in a conventional technology can be resolved to some extent. In some embodiments of this disclosure, the resin composition includes the curing monomer containing the free radical polymerizable group and the moisture curable group, so that the resin composition has both a UV light curing characteristic and a moisture curing characteristic, thereby obtaining better curing effect.

In an embodiment of this disclosure, the curing monomer may include one or more compounds, and a weight-average molecular weight of each component, namely, each compound, of the curing monomer is greater than or equal to 300. In some embodiments of this disclosure, a weight-average molecular weight of the curing monomer is greater than or equal to 500. It is more difficult to penetrate into skin when the molecular weight is greater than or equal to 500, so that an allergy risk caused by contact with human skin can be better reduced, and a user allergy problem can be better resolved. In some embodiments of this disclosure, the weight-average molecular weight of the curing monomer may be 500-1000. A curing monomer with a suitable molecular weight is selected, and the viscosity of the resin composition can be controlled as much as possible under a condition that an allergy risk is effectively reduced, so that the curing monomer can play a dilution role to some extent.

In an embodiment of this disclosure, a weight-average molecular weight of the polyurethane acrylate may be greater than or equal to 500 and less than or equal to 5000. If the polyurethane acrylate whose weight-average molecular weight is greater than or equal to 500 is selected, it is helpful to reduce the allergy risk of the resin composition to human skin. However, if the polyurethane acrylate whose weight-average molecular weight is less than or equal to 5000 is selected, properties such as overall viscosity of the resin composition can be better controlled, thereby lowering a requirement for dilution of a low-molecular-weight curing monomer, and better adapting to a resin system in which the weight-average molecular weight of the curing monomer is greater than or equal to 300 in this disclosure.

In an embodiment of this disclosure, VOC content before and after the resin composition is cured is less than 20 mg/g. A VOC is a volatile organic compound (Volatile Organic Compound), and has great impact on human health. The World Health Organization (WHO) refers to a volatile organic compound whose melting point is below a room temperature and boiling point is between 50-260° C. as a VOC. In this disclosure, the VOC content before and after the resin composition is cured is low, is more environmentally friendly, is conducive to human health, and reduces a human allergy risk.

In an embodiment of this disclosure, weight content of a non-volatile substance before and after the resin composition is cured is greater than or equal to 98.5%. Higher weight content of the non-volatile substance means lower weight content of a volatile substance and lower VOC content. Therefore, this is conducive to human health and reduces a human allergy risk.

In an embodiment of this disclosure, in the resin composition, mass proportions of the polyurethane acrylate and the curing monomer are respectively 50%-90% and 10%-50%.

In an embodiment of this disclosure, the resin composition further includes a photoinitiator. In an embodiment of this disclosure, in the resin composition, a mass proportion of the photoinitiator is 0.5%-5%.

The polyurethane acrylate is a prepolymer, and is a main bonding material, which ensures bonding performance of the resin composition. The curing monomer has reaction activity, and can react, thereby increasing crosslinking of the resin composition. The photoinitiator, as an optical energy absorption carrier, may generate active fragments that can trigger polymerization of the polyurethane acrylate and the curing monomer. Each component of the resin composition is controlled within the foregoing mass proportion range, so that better curing effect and better bonding effect can be obtained.

In an embodiment of this disclosure, the curing monomer includes the compound containing at least one of the free radical polymerizable group or the compound containing the moisture curable group. In some embodiments of this disclosure, the curing monomer includes the compound containing the free radical polymerizable group, and the compound does not contain the moisture curable group. In some other implementations of this disclosure, the curing monomer includes the compound containing the moisture curable group, and the compound does not contain the free radical polymerizable group. In some other implementations of this disclosure, the curing monomer includes both the compound containing the free radical polymerizable group and the compound containing the moisture curable group, and the resin composition includes the curing monomer containing the free radical polymerizable group and the moisture curable group. In this implementation, the compound containing the free radical polymerizable group and the compound containing the moisture curable group may be a same compound. In other words, the compound is a compound containing both the free radical polymerizable group and the moisture curable group, that is, the free radical polymerizable group and the moisture curable group are provided by the same compound. Alternatively, the compound containing the free radical polymerizable group and the compound containing the moisture curable group may be different compounds, and the compound containing the free radical polymerizable group contains only a compound of the free radical polymerizable group, and does not contain the moisture curable group. The compound containing the moisture curable group contains only a compound of the moisture curable group, and does not contain the free radical polymerizable group. In other words, the free radical polymerizable group and the moisture curable group are provided by different compounds. The free radical polymerizable group may undergo a reaction under UV light, so that the resin composition is cured; and the moisture curable group may react with water vapor, so that the resin composition is cured.

In an embodiment of this disclosure, the free radical polymerizable group may be an unsaturated double bond. In an embodiment of this disclosure, the moisture curable group may include one or more of an isocyanate-terminated group and an alkoxysilyl group. Both the isocyanate-terminated group and the alkoxysilyl group can react with moisture in air for moisture curing. In some embodiments of this disclosure, the curing monomer includes the compound containing at least one of the free radical polymerizable group or a compound containing the isocyanate-terminated group. In some other implementations of this disclosure, the curing monomer includes the compound containing at least one of the free radical polymerizable group or a compound containing the alkoxysilyl group. In some embodiments of this disclosure, the curing monomer includes a compound containing both the free radical polymerizable group and the isocyanate-terminated group. In some other implementations of this disclosure, the curing monomer includes a compound containing both the free radical polymerizable group and the alkoxysilyl group.

An existing UV light curing adhesive may be cured under ultraviolet light. However, in actual disclosure, a shadow part that is not illuminated by the ultraviolet light cannot be cured, and consequently a mechanical property of the cured adhesive is greatly reduced. When the curing monomer in the resin composition in this embodiment of this disclosure has both the free radical polymerizable group capable of UV light curing and the moisture curable group capable of moisture curing with water vapor, the resin can have a double curing function of both UV light curing and moisture curing. In other words, the resin composition in this disclosure can be cured quickly under light, and be cured by moisture in air in an unexposed place. After UV curing, the monomer can still be continuously cured by moisture, thereby improving a curing rate and resolving a problem that the shadow part cannot be cured in a light polymerization process. The resin composition has a UV light-moisture double curing characteristic, which can ensure that the resin composition is more completely cured, and improve bonding effect of the resin composition. Especially for a bonding structure that cannot be completely irradiated by light, the curing bonding effect is improved more significantly.

In an embodiment of this disclosure, a functionality of an isocyanate of the compound containing the free radical polymerizable group and the isocyanate-terminated group is greater than or equal to 2. If the functionality of the isocyanate is greater, curing can be better completed through reaction of an isocyanate group and water.

In an embodiment of this disclosure, the curing monomer includes a compound represented by the following formula (1):

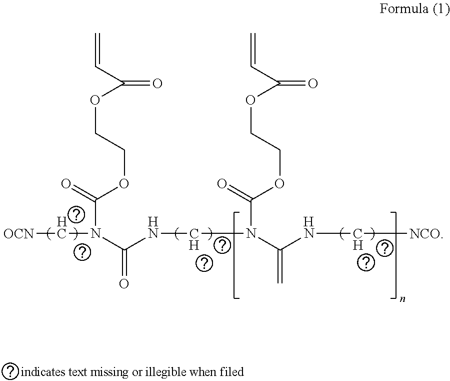

In the formula (1), m and n are positive integers. In an embodiment, m may be an integer 2-20, and n may be an integer greater than or equal to 1. For example, n may be 1, 2, 3, 4, 5, 6, 7, 8, 9, 10, or the like.

In another implementation of this disclosure, the curing monomer includes a compound represented by the following formula (2):

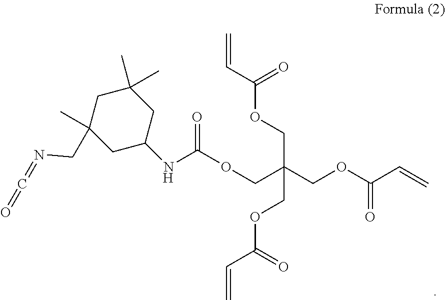

In an embodiment of this disclosure, the photoinitiator may be various compounds that can absorb energy of a specific wavelength in an ultraviolet light region (250-420 nm) to generate active fragments (such as free radicals, cations, and anions) and therefore trigger polymerization, crosslinking, and curing of monomers. The photoinitiator may enable curing monomers to implement fast crosslinking and curing under light. In this embodiment of this disclosure, the photoinitiator may be one or more of an α-hydroxy ketone photoinitiator, an acylphosphine oxide photoinitiator, a benzyl formate photoinitiator, a benzil photoinitiator, a benzophenone photoinitiator, and an oxime ester photoinitiator.

In an embodiment of this disclosure, the resin composition further includes a thiol. Addition of the thiol can improve curing performance of the resin composition. In an embodiment, as a free radical chain transfer agent, addition of the thiol can improve sensitivity of the resin composition, increase deep curing, and further improve curing performance of a part of a low-light region. In an embodiment of this disclosure, in the resin composition, a mass proportion of the thiol is less than or equal to 3%. The addition of the thiol is controlled to be 3% or less, so that the curing performance of the resin composition can be improved and the resin composition storage is not unstable due to excessive content of the thiol.

In an embodiment of this disclosure, the thiol may include one or more of pentaerythritol tetrakis(3-mercaptobutyric acid) ester (CAS No. 31775-89-0), pentaerythritol tetrakis(3-mercaptopropionic acid) ester (CAS No. 7575-23-7), tris[2-(3-mercaptopropionyloxy)ethyl] isocyanurate (CAS No. 36196-44-8), and trimethylolpropane tris(3-mercaptopropionic acid ester) (CAS No. 33007-83-9).

In an embodiment of this disclosure, the polyurethane acrylate may be prepared in the following manner:
under a condition that a catalyst and an antioxidant exist, mixing a polyol and an isocyanate ethyl acrylate monomer, and mixing and reacting for 4-12 hours at 40-100° C., to obtain the polyurethane acrylate.

A prepolymer material of the polyurethane acrylate is prepared by using the foregoing method, and a polyurethane prepolymer having a lower molecular weight and narrow molecular weight distribution may be synthesized by using a one-step method, thereby reducing a process and improving production efficiency.

In an embodiment of this disclosure, the polyol may be a polyol substance in various forms, for example, may be one or more of a polyester polyol, a polycarbonate polyol, a polyether polyol, a polytetramethylene ether glycol, a polycaprolactone polyol, or a copolymer of the foregoing polyols. A molecular weight of the polyurethane acrylate can be controlled at a lower level by selecting a molecular weight of the polyol.

In an embodiment of this disclosure, the catalyst may be one or more of an organic bismuth compound, an organic zinc compound, and an organic titanium compound.

In an embodiment of this disclosure, the antioxidant may include an alkylphenol antioxidant, and the alkylphenol antioxidant is, for example, one or more of 2,6-di-tert-butyl-p-methylphenol (BHT), 2,4-di-tert-butylphenol, and o-tert-butylphenol (that is, 2-tert-butylphenol).

In an embodiment of this disclosure, a shear strength of the resin composition is greater than or equal to 1 Mpa.

A second aspect of this disclosure provides a method for preparing a resin composition, including the following steps:
mixing a polyurethane acrylate and a curing monomer to obtain the resin composition, where the curing monomer includes a compound containing at least one of a free radical polymerizable group or a compound containing a moisture curable group, and a weight-average molecular weight of the curing monomer is greater than or equal to 300.

A third aspect of embodiments of this disclosure provides an adhesive. The adhesive includes the resin composition according to the first aspect of embodiments of this disclosure.

A fourth aspect of embodiments of this disclosure provides a resin curing product. The resin curing product is obtained by curing the resin composition according to the first aspect of embodiments of this disclosure. In an embodiment of this disclosure, the curing includes at least one of ultraviolet light curing or moisture curing.

A fifth aspect of embodiments of this disclosure provides a bonding structure. The bonding structure includes a first bonding member, a second bonding member, and a bonding part disposed between the first bonding member and the second bonding member, and the bonding part includes a curing product obtained by curing the resin composition according to the first aspect of embodiments of this disclosure or the adhesive according to the third aspect, or includes the resin curing product according to the fourth aspect of embodiments of this disclosure. The first bonding member and the second bonding member may be any functional element that needs to be bonded and fastened together.

In an embodiment of this disclosure, the first bonding member may be made of plastic, metal, glass, or the like, and the second bonding member may be made of plastic, metal, glass, or the like.

This disclosure further provides a device. The device includes the bonding structure according to the fifth aspect of embodiments of this disclosure. The device may be any one of various electronic devices, or another device on which the bonding structure needs to be disposed. The electronic device may include a wearable device (for example, a headset, glasses, a watch, a wristband, a wrist strap, a helmet, or a headband), a mobile phone, a tablet computer, a notebook computer, a laptop computer, an ultra-mobile personal computer (UMPC), a handheld computer, an intercom, a netbook, a POS machine, a personal digital assistant (PDA), an automobile data recorder, a virtual reality device, a wireless USB flash drive, a Bluetooth stereo, an in-vehicle product, or the like. A resin composition in embodiments of this disclosure is used as an adhesive to form a bonding structure. The resin composition has a UV light-moisture double curing characteristic, good curing bonding effect, low volatility, and a low allergy risk, so that product competitiveness of the electronic device can be improved.

In some embodiments of this disclosure, the device is a wearable device.

Embodiments of this disclosure further provide a disclosure of a resin composition in an electronic device. The disclosure is that the resin composition is used as an adhesive in the electronic device.

An embodiment of this disclosure further provides a wearable device. The wearable device includes a housing and an element fastened to the housing by using an adhesive, and the adhesive includes the adhesive according to the third aspect of embodiments of this disclosure.

### BRIEF DESCRIPTION OF DRAWINGS

FIG. 1 is a diagram of a bonding structure according to an embodiment of this disclosure;

FIG. 2 is a diagram of a structure of a wearable device according to some embodiments of this disclosure;

FIG. 3 is a diagram of bonding and fastening a wearable device by using a resin composition according to some embodiments of this disclosure;

FIG. 4 is a diagram of setting a sample during a shear strength test of a resin composition according to this disclosure;

FIG. 5 is a representation diagram of an infrared spectrum of a polyurethane A prepared according to Embodiment 1 of this disclosure;

FIG. 6 is a representation diagram of an infrared spectrum of a polyurethane B prepared according to Embodiment 2 of this disclosure; and

FIG. 7 is a representation diagram of an infrared spectrum of a polyurethane C prepared according to Embodiment 3 of this disclosure.

### DESCRIPTION OF EMBODIMENTS

The following describes embodiments of this disclosure with reference to the accompanying drawings in embodiments of this disclosure.

Currently, in a process in which a UV curing adhesive or a UV moisture curing adhesive that is used to fasten a part and that is in a wearable device such as a headset is cured, a component of a low molecular weight cannot be 100% cured. Consequently, when a user wears the wearable device such as the headset, the element of the low molecular weight volatilizes, causing an allergy of the user. To reduce an allergy risk of using the wearable device such as the headset by the user, an embodiment of this disclosure provides a resin composition. VOC content before and after the resin composition is cured is low, and the resin composition may be used as an adhesive in a device such as a headset, to implement reliable fastening and bonding, and effectively resolve a human allergy problem caused by the adhesive.

The resin composition provided in this embodiment of this disclosure includes a polyurethane acrylate and a curing monomer, the curing monomer includes a compound containing at least one of a free radical polymerizable group or a compound containing a moisture curable group, and a weight-average molecular weight of the curing monomer is greater than or equal to 300.

According to the resin composition provided in this embodiment of this disclosure, a curing monomer whose molecular weight is greater than or equal to 300 is selected, so that volatility before and after the resin composition is cured can be reduced, and an allergy risk of the resin composition to human skin can be reduced. Therefore, when the resin composition is used as an adhesive in a device such as a headset, reliable fastening and bonding can be implemented, and a human allergy problem caused by the adhesive in a conventional technology can be resolved to some extent.

In an embodiment of this disclosure, the curing monomer may include one or more compounds, and a weight-average molecular weight of each component, namely, each compound, of the curing monomer is greater than or equal to 300. In some embodiments of this disclosure, a weight-average molecular weight of the curing monomer is greater than or equal to 500. According to the 500 Dalton rule, it is more difficult for a compound whose molecular weight is greater than or equal to 500 to penetrate into skin. When the resin composition in this embodiment of this disclosure is used as the adhesive, even if some curing monomers are not completely reacted and cured, a possibility of an allergy risk caused by contact with human skin can be better reduced, thereby better resolving a user allergy problem. In some embodiments of this disclosure, the weight-average molecular weight of the curing monomer is 500-1000, and may be, for example, 500, 600, 700, 800, 900, or 1000. A curing monomer with a suitable molecular weight is selected, and viscosity of the resin composition can be controlled as much as possible under a condition that an allergy risk is effectively reduced, so that the curing monomer can play a dilution role to some extent.

In an embodiment of this disclosure, a weight-average molecular weight of the polyurethane acrylate is greater than or equal to 500 and less than or equal to 5000. If the polyurethane acrylate whose the weight-average molecular weight is greater than or equal to 500 is selected, it is helpful to reduce the allergy risk of the resin composition to human skin. However, if the polyurethane acrylate whose the weight-average molecular weight is less than or equal to 5000 is selected, properties such as overall viscosity of the resin composition can be better controlled, thereby meeting feasibility of dispensing process processing, lowering a requirement for dilution of a low-molecular-weight curing monomer, and better adapting to a resin system in which the molecular weight of the curing monomer is greater than or equal to 300 in this disclosure. In some embodiments, the weight-average molecular weight of the polyurethane acrylate may be, for example, 500, 1000, 2000, 2500, 2700, 3000, 4000, or 5000. The resin composition in this disclosure may include one or more polyurethane acrylates. In this embodiment of this disclosure, a PDI (polymer dispersity index) of the polyurethane acrylate is less than or equal to 2, that is, the PDI of the polyurethane acrylate is small, and material uniformity is high. This helps improve overall performance uniformity of the resin composition. In this disclosure, a unit of a molecular weight of each substance is a standard unit g/mol.

In an embodiment of this disclosure, the VOC content before and after the resin composition is cured is less than 20 mg/g. A VOC is a volatile organic compound (Volatile Organic Compound), and has great impact on human health. The World Health Organization (WHO) refers to a volatile organic compound whose melting point is below a room temperature and boiling point is between 50-260° C. as a VOC. In this disclosure, the VOC content before and after the resin composition is cured is low, is more environmentally friendly, is conducive to human health, and reduces a human allergy risk. In some embodiments of this disclosure, the VOC content before and after the resin composition is cured is less than or equal to 18 mg/g. In some embodiments of this disclosure, the VOC content before and after the resin composition is cured is less than or equal to 15 mg/g.

In an embodiment of this disclosure, weight content of a non-volatile substance before and after the resin composition is cured is greater than or equal to 98.5%. In some embodiments, the weight content of the non-volatile substance before and after the resin composition is cured is greater than or equal to 98.8%. Higher weight content of the non-volatile substance means lower weight content of a volatile substance and lower VOC content. Therefore, this is conducive to human health and reduces a human allergy risk. The weight content of the non-volatile substance before and after the resin composition is cured is greater than or equal to 98.5%, that is, the weight content of the volatile substance is less than or equal to 15 mg/g.

In an embodiment of this disclosure, in the resin composition, mass proportions of the polyurethane acrylate, the curing monomer, and a photoinitiator are respectively 50%-90%, 10%-50%, and 0.5%-5%. The polyurethane acrylate is a prepolymer, and is a main bonding material, which ensures bonding performance of the resin composition. The bonding property of the resin composition can be ensured by controlling the mass proportion of the polyurethane acrylate to 50%-90%. The curing monomer has reaction activity, and can react, thereby increasing crosslinking of the resin composition; and the curing monomer has a function of diluting the polyurethane acrylate, and the foregoing function can be better fulfilled when the mass proportion of the curing monomer is controlled to 10%-50%. When viscosity of the polyurethane acrylate is high, a quantity of curing monomers can be increased. The photoinitiator, as an optical absorption carrier, may generate active fragments that can trigger polymerization of the polyurethane acrylate and the curing monomer. Each component of the resin composition is controlled within the foregoing weight range, so that better curing effect and better bonding effect can be obtained. In some embodiments of this disclosure, in the resin composition, the mass proportion of the polyurethane acrylate may be 50%, 60%, 70%, 80%, or 90%; the mass proportion of the curing monomer may be 10%, 20%, 30%, 40%, or 50%; and the mass proportion of the photoinitiator may be 0.5%, 1%, 1.5%, 2%, 3%, 4%, or 5%. In some embodiments, in the resin composition, a mass ratio of the polyurethane acrylate to the curing monomer is 3-6:1. In an embodiment, the mass ratio is, for example, 3:1, 4:1, 5:1, or 6:1. The mass ratio of the polyurethane acrylate to the curing monomer is controlled in the foregoing range, so that the resin composition can obtain better comprehensive performance.

In an embodiment of this disclosure, the curing monomer includes the compound containing at least one of the free radical polymerizable group or the compound containing the moisture curable group. The free radical polymerizable group may undergo a free radical polymerization reaction under UV light, so that the resin composition is cured; and the moisture curable group may react with water vapor, so that the resin composition is cured. In some other implementations of this disclosure, the curing monomer includes the compound containing the moisture curable group, and the compound does not contain the free radical polymerizable group. In some other implementations of this disclosure, the curing monomer includes both the compound containing the free radical polymerizable group and the compound containing the moisture curable group, and the resin composition includes the curing monomer containing the free radical polymerizable group and the moisture curable group. In this implementation, the compound containing the free radical polymerizable group and the compound containing the moisture curable group may be a same compound. In other words, the compound is a compound containing both the free radical polymerizable group and the moisture curable group, that is, the free radical polymerizable group and the moisture curable group are provided by the same compound. Alternatively, the compound containing the free radical polymerizable group and the compound containing the moisture curable group may be different compounds, and the compound containing the free radical polymerizable group contains only a compound of the free radical polymerizable group, and does not contain the moisture curable group. The compound containing the moisture curable group contains only a compound of the moisture curable group, and does not contain the free radical polymerizable group. In other words, the free radical polymerizable group and the moisture curable group are provided by different compounds. The free radical polymerizable group may undergo a reaction under UV light, so that the resin composition is cured; and the moisture curable group may react with water vapor, so that the resin composition is cured. The resin composition includes the curing monomer containing the free radical polymerizable group and the moisture curable group, so that the resin composition has both a UV light curing characteristic and a moisture curing characteristic, thereby obtaining better curing effect.

In an embodiment of this disclosure, the free radical polymerizable group may be an unsaturated double bond. In an embodiment of this disclosure, the moisture curable group may include one or more of an isocyanate-terminated group and an alkoxysilyl group. Both the isocyanate-terminated group and the alkoxysilyl group can react with moisture in air for moisture curing. In some embodiments of this disclosure, the curing monomer includes the compound containing at least one of the free radical polymerizable group or a compound containing the isocyanate-terminated group. In some other implementations of this disclosure, the curing monomer includes the compound containing at least one of the free radical polymerizable group or a compound containing the alkoxysilyl group. In some embodiments of this disclosure, the curing monomer includes a compound containing both the free radical polymerizable group and the isocyanate-terminated group. In some other implementations of this disclosure, the curing monomer includes a compound containing both the free radical polymerizable group and the alkoxysilyl group.

An existing UV light curing adhesive may be cured under ultraviolet light. However, in actual disclosure, a shadow part that is not illuminated by the ultraviolet light cannot be cured, and consequently a mechanical property of the cured adhesive is greatly reduced. When a molecular chain of the curing monomer in the resin composition in this embodiment of this disclosure has both the free radical polymerizable group capable of UV light curing and the moisture curable group capable of moisture curing with water vapor, the resin can have a double curing function of both UV light curing and moisture curing. In other words, the resin composition in this disclosure can be cured quickly under light, and be cured by moisture in air in an unexposed place. After UV curing, the monomer can still be continuously cured by moisture, thereby improving a curing rate and resolving a problem that the shadow part cannot be cured in a light polymerization process. The resin composition has a UV light-moisture double curing characteristic, which can ensure that the resin composition is more completely cured, and improve bonding effect of the resin composition. Especially for a bonding structure that cannot be completely irradiated by light, the curing bonding effect is improved more significantly.

A specific chemical structure of the curing monomer in this disclosure is not limited, and may be various specific structures. Specific chemical structures of the compound that contains both the free radical polymerizable group and the isocyanate-terminated group, and the curing monomer that contains both the free radical polymerizable group and the alkoxysilyl group are not limited. In an embodiment of this disclosure, a functionality of an isocyanate of the compound containing both the free radical polymerizable group and the isocyanate-terminated group may be greater than or equal to 2. If the functionality of the isocyanate is greater, curing can be better completed through reaction of an isocyanate group and water.

In a specific implementation of this disclosure, the compound containing both the free radical polymerizable group and the isocyanate-terminated group includes a compound represented by the following formula (1):

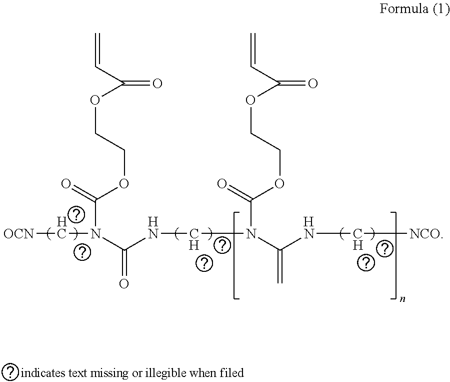

In the formula (1), m and n are positive integers. In an embodiment, m may be an integer 2-20, and n may be an integer greater than or equal to 1. For example, m may be 2, 3, 4, 5, 6, 7, 8, 9, 10, 11, 12, 13, 14, 15, 16, 17, 18, 19, 20, or the like, and n may be 1, 2, 3, 4, 5, 6, 7, 8, 9, 10, or the like.

In another implementation of this disclosure, the compound containing both the free radical polymerizable group and the isocyanate-terminated group includes a compound represented by the following formula (2):

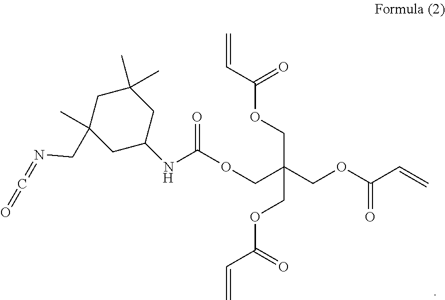

The compound represented by the formula (2) may be formed by reaction of pentaerythritol triacrylate (PETIA) and isofolone diisocyanate (IPDI).

In an embodiment of this disclosure, the photoinitiator may be various compounds that can absorb energy of a specific wavelength in an ultraviolet light region (250-420 nm) to generate active fragments (such as free radicals, cations, and anions) and therefore trigger polymerization, crosslinking, and curing of monomers. The photoinitiator may enable curing monomers to implement fast crosslinking and curing under light. The photoinitiator may be a photoinitiator with low oxygen inhibition and high sensitivity. The photoinitiator with low oxygen inhibition can achieve a high reaction rate under lower content of the photoinitiator, thereby improving curing efficiency and curing effect. The resin composition may include one or more photoinitiators. In some embodiments of this disclosure, the photoinitiator may be one or more of an α-hydroxy ketone photoinitiator, an acylphosphine oxide photoinitiator, a benzyl formate photoinitiator, a benzil photoinitiator, a benzophenone photoinitiator, and an oxime ester photoinitiator. In some embodiments, the photoinitiator may include the α-hydroxy ketone photoinitiator and the acylphosphine oxide photoinitiator.

In an embodiment of this disclosure, the resin composition further includes a thiol. Addition of the thiol can improve curing performance of the resin composition. In an embodiment, as a free radical chain transfer agent, addition of the thiol can improve sensitivity of the resin composition, increase deep curing, and further improve curing performance of a part of a low-light region. In an embodiment of this disclosure, in the resin composition, a mass proportion of the thiol is less than or equal to 3%. In an embodiment, the mass proportion of the thiol may be 0.4%-3%, for example, 0.4%, 0.5%, 1%, 1.5%, 2%, 2.5%, or 3%. The addition of the thiol is controlled to be 3% or less, so that the curing performance of the resin composition can be improved and the resin composition storage is not unstable due to excessive content of the thiol.

In an embodiment of this disclosure, the resin composition may include one or more types of thiols, and specific selection of the thiol is not limited. The thiol may include one or more of pentaerythritol tetrakis(3-mercaptobutyric acid) ester (CAS No. 31775-89-0), pentaerythritol tetrakis(3-mercaptopropionic acid) ester (CAS No. 7575-23-7), tris[2-(3-mercaptopropionyloxy)ethyl] isocyanurate (CAS No. 36196-44-8), and trimethylolpropane tris(3-mercaptopropionic acid ester) (CAS No. 33007-83-9).

In an embodiment of this disclosure, a specific structure of the polyurethane acrylate is not limited. The polyurethane acrylate may be obtained by polymerizing a polyol and an isocyanate ethyl acrylate monomer. The polyurethane acrylate may be prepared in the following manner:
under a condition that a catalyst and an antioxidant exist, mixing a polyol and an isocyanate ethyl acrylate monomer, and mixing and reacting for 4-12 hours at 40-100° C., to obtain the polyurethane acrylate.

A prepolymer material of the polyurethane acrylate is prepared by using the foregoing method, and a polyurethane prepolymer having a lower molecular weight and narrow molecular weight distribution may be synthesized by using a one-step method, thereby reducing a process and improving production efficiency. The preparation of the polyurethane acrylate is not limited to the foregoing method, and any method that can implement the preparation of the polyurethane acrylate may be used.

In an embodiment of this disclosure, the polyol may be a polyol substance in various forms, for example, may be one or more of a polyester polyol, a polycarbonate polyol, a polyether polyol, a polytetramethylene ether glycol, a polycaprolactone polyol, or a copolymer of the foregoing polyols. The polyol may be slightly excessively added relative to the isocyanate ethyl acrylate monomer. For example, the polyol may be added at a chemical measurement ratio of a hydroxy group to an isocyanate group of 1.05-1.2:1. A type of the polyol determines a final molecular structure of the polyurethane acrylate.

In an embodiment of this disclosure, the catalyst may be one or more of an organic bismuth compound, an organic zinc compound, and an organic titanium compound. The organic bismuth compound, the organic zinc compound, and the organic titanium compound are environmentally friendly catalysts, and can reduce an allergy risk. The organic bismuth compound is an organic bismuth catalyst, and may be, for example, bismuth isooctanoate, bismuth laurate, bismuth neodecanoate, or the like. The organic zinc compound is an organic zinc catalyst, and may be, for example, dimethyl zinc, diethyl zinc, or the like. The organic titanium compound is an organic titanium catalyst, and may be, for example, titanate. The catalyst may be added 100-300 ppm relative to mass of the isocyanate ethyl acrylate monomer.

In an embodiment of this disclosure, the antioxidant may include an alkylphenol antioxidant, and the alkylphenol antioxidant is, for example, one or more of 2,6-di-tert-butyl-p-methylphenol (BHT), 2,4-di-tert-butylphenol, and o-tert-butylphenol (that is, 2-tert-butylphenol). The antioxidant may be added 200-1000 ppm relative to the mass of the isocyanate ethyl acrylate monomer.

In this embodiment of this disclosure, a temperature of a polyurethane acrylate preparation reaction may be 40° C., 50° C., 60° C., 70° C., 80° C., 90° C., 100° C., or the like, and a time period may be 4 hours, 5 hours, 6 hours, 7 hours, 8 hours, 9 hours, 10 hours, 11 hours, 12 hours, or the like.

A shear strength of the resin composition in this embodiment of this disclosure is greater than or equal to 1 Mpa, indicating that the resin composition has good bonding performance. The shear strength is an ultimate strength generated when a material is cut off, which reflects a capability of the material to resist shear and sliding. A value is equal to a tangential stress value on a shear surface, that is, a ratio of a shear force formed on the shear surface to a damage area. A greater shear strength of an adhesive indicates better bonding effect.

This disclosure further provides a method for preparing the foregoing resin composition, including the following steps:
mixing a polyurethane acrylate, a curing monomer, and a photoinitiator to obtain the resin composition, where the curing monomer includes a compound containing at least one of a free radical polymerizable group or a compound containing a moisture curable group, and a weight-average molecular weight of the curing monomer is greater than or equal to 300.

In some embodiments, a thiol is further added in the mixing process. After the polyurethane acrylate, the curing monomer, the photoinitiator, and the thiol are mixed evenly, defoaming treatment can be further performed.

An embodiment of this disclosure further provides an adhesive. The adhesive includes the foregoing resin composition in embodiments of this disclosure. The adhesive in this embodiment of this disclosure may be used for bonding and fastening various to-be-bonded members. VOC content before and after the adhesive is cured is low, an allergy risk is low, and a bonding binding force is strong. The adhesive may be used in an electronic device such as a wearable device, to improve product competitiveness of the electronic device. When a part of the electronic device is assembled and fastened, the adhesive may be coated on a to-be-bonded surface of the to-be-bonded element, or may be coated in a dispensing manner.

A shear strength of the adhesive in this embodiment of this disclosure is greater than or equal to 1 Mpa, indicating that the adhesive has good bonding performance.

An embodiment of this disclosure further provides a resin curing product, and the resin curing product is obtained by curing the foregoing resin composition in embodiments of this disclosure. In an embodiment of this disclosure, the curing may include at least one of ultraviolet light curing or moisture curing. A light curing condition may be: a UV light wavelength of 365 nm, and irradiation energy of 6000 mj/cm².

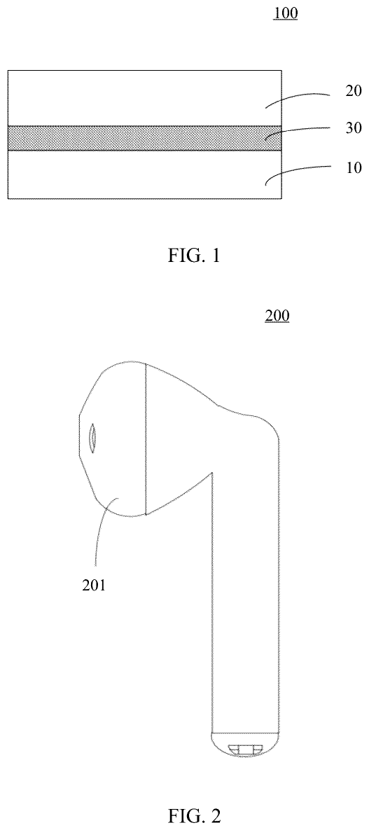

Refer to FIG. 1. An embodiment of this disclosure further provides a bonding structure 100. The bonding structure 100 includes a first bonding member 10, a second bonding member 20, and a bonding part 30 disposed between the first bonding member 10 and the second bonding member 20. The bonding part 30 includes a curing product obtained by curing the foregoing resin composition or adhesive in embodiments of this disclosure. The first bonding member 10 and the second bonding member 20 may be any functional element that needs to be bonded and fastened together, and a specific shape and a specific structure are not limited.

In an embodiment of this disclosure, the first bonding member 10 may be made of plastic, metal, glass, or the like, and the second bonding member 20 may also be made of plastic, metal, glass, or the like.

This disclosure further provides a device. The device includes the foregoing bonding structure in embodiments of this disclosure. To be specific, the resin composition provided in embodiments of this disclosure is used for assembling and fastening of an element of the device. The device may be any one of various electronic devices, or another device that needs to be assembled and fastened by using an adhesive and that is provided with the bonding structure. The electronic device may include a wearable device (for example, a headset, glasses, a watch, a wristband, a wrist strap, a helmet, or a headband), a mobile phone, a tablet computer, a notebook computer, a laptop computer, an ultra-mobile personal computer (UMPC), a handheld computer, an intercom, a netbook, a POS machine, a personal digital assistant (PDA), an automobile data recorder, a virtual reality device, a wireless USB flash drive, a Bluetooth stereo, an in-vehicle product, or the like. The resin composition in this embodiment of this disclosure is used as an adhesive to form the bonding structure, so that curing bonding effect is good, volatility is low, and an allergy risk is low, thereby improving product competitiveness of the electronic device and improving user experience in health.

Refer to FIG. 2. In some embodiments of this disclosure, the device is a wearable device 200, and the wearable device 200 includes a housing 201 and a functional part disposed inside the housing 201. In an embodiment, FIG. 2 is a diagram of a structure of the wearable device 200 being a headset. In the wearable device 200, a first bonding member 10 and a second bonding member 20 may be any functional elements that need to be bonded, that is, to be bonded and fastened together. For example, the first bonding member 10 may be a housing of the wearable device, or may be a bearing substrate, a bearing support, or the like, and the second bonding member 20 may be any one of various wearable device elements that need to be fastened to the housing or the bearing substrate/bearing support, for example, a microphone, a sound output net, a light guide, a lining support, or a distance sensor. The resin composition in this disclosure has low volatility. Using the resin composition in this disclosure can reduce an allergy risk when a user wears the wearable device, and improve user experience in wearing health.

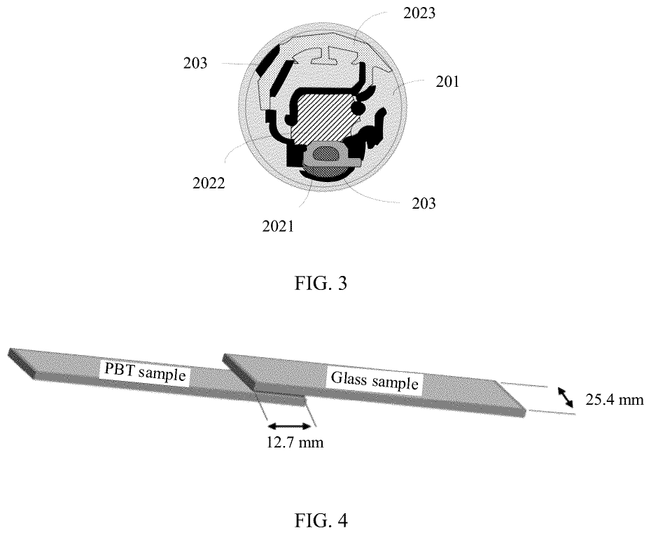

FIG. 3 is a diagram of bonding and fastening the wearable device 200 by using a resin composition according to some embodiments of this disclosure. A plurality of functional parts are disposed inside the housing 201. The functional elements include a sound output net 2021, a light guide 2022, a lining support 2023, and the like. The functional elements are fastened to the housing 201 by using a connection part 203 formed by an adhesive. The functional element may be directly fastened to the housing 201 by using an adhesive, or may be indirectly fastened to the housing 201. The indirect fastening may be, for example, that the functional element is first fastened to the bearing substrate or bearing support by using an adhesive, and then fastened to the housing, or may be fastened in another form. It may be understood that, in an actual product, in addition to a part visible in FIG. 3, the connection part 203 formed by the adhesive includes a part that is not shown in FIG. 3 and that is not visible between the functional element and the housing.

It should be noted that in this disclosure, “-” represents a value range, including two endpoint values. For example, “50%-90%” includes two endpoint values 50% and 90% and all values between the two endpoint values.

Embodiments of this disclosure are further described below by using a plurality of embodiments.

### Embodiment 1

### Preparation of a Low-Molecular-Weight Polyurethane Acrylate a (Weight-Average Molecular Weight 1344):

Put a 100 ppm catalyst (relative to 1gAOI) and a 200 ppm antioxidant (relative to 1gAOI) into a beaker, and then add polycarbonate diol (synthesized by using 2-methyl-2,4-pentadiol (MPD), 1,6-hexylene glycol (1,6-HD), and diethyl carbonate (DEC) as raw materials, a number-average molecular weight Mn=557, and a weight-average molecular weight Mw=1293) into the beaker. After a temperature rises to 80° C., add dropwise an isocyanate ethyl acrylate (AOI) monomer to the polycarbonate diol until a chemical measurement ratio of a hydroxy group to an isocyanate group is 1.05-1.2:1. After 4-12 hours of mixing and reacting, prepare the low-molecular-weight polyurethane acrylate A (polyurethane A for short), where a weight-average molecular weight Mw of the obtained polyurethane A is 1344, a number-average molecular weight Mn is 683, viscosity is 3600, and a PDI (polymer dispersity index, polymer dispersity index) is 1.97.

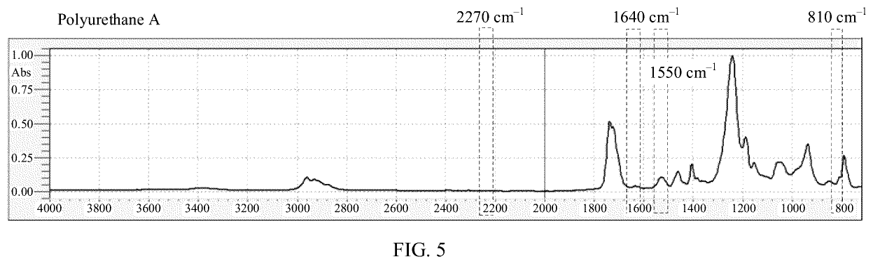

FIG. 5 is a representation diagram of an infrared spectrum of the polyurethane A prepared according to Embodiment 1 of this disclosure. It can be learned from FIG. 5 that there is no peak at a characteristic peak location 2270 cm⁻¹ of the isocyanate group-NCO, indicating that isocyanate group reaction is complete. In addition, there are obvious peaks at C═C characteristic peak locations 1640 cm⁻¹ and 810 cm⁻¹, and at an N—H characteristic peak location 1550 cm⁻¹, indicating that C═C and N—H exist in a molecular structure of the polyurethane A.

### Embodiment 2

### Preparation of a Low-Molecular-Weight Polyurethane Acrylate B (Weight-Average Molecular Weight 2503):

Put a 100 ppm catalyst (relative to 1gAOI) and a 200 ppm antioxidant (relative to 1gAOI) into a beaker, and then add polycarbonate diol (synthesized by using 2-methyl-2,4-pentadiol (MPD), 1,6-hexylene glycol (1,6-HD), and diethyl carbonate (DEC) as raw materials, a number-average molecular weight Mn=1083, and a weight-average molecular weight Mw=2313) into the beaker. After a temperature rises to 80° C., add dropwise an isocyanate ethyl acrylate (AOI) monomer to a polyol until a chemical measurement ratio of a hydroxy group to an isocyanate group is 1.05-1.2:1. After 4-12 hours of mixing and reacting, prepare the low-molecular-weight polyurethane acrylate B (polyurethane B for short), where a weight-average molecular weight Mw of the obtained polyurethane B is 2503, a number-average molecular weight Mn is 1340, viscosity is 27840, and a PDI is 1.87.

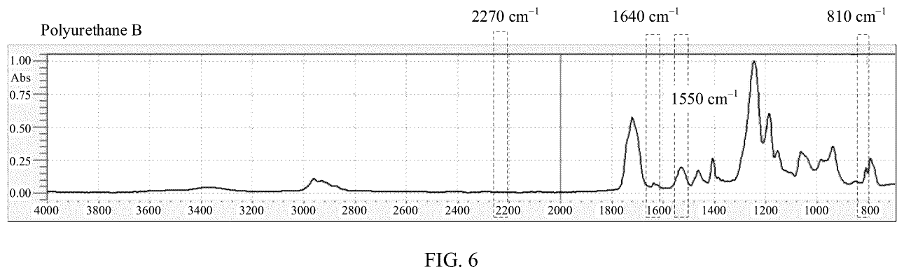

FIG. 6 is a representation diagram of an infrared spectrum of the polyurethane B prepared according to Embodiment 2 of this disclosure. It can be learned from FIG. 6 that there is no peak at a characteristic peak location 2270 cm⁻¹ of the isocyanate group-NCO, indicating that isocyanate group reaction is complete. In addition, there are obvious peaks at C═C characteristic peak locations 1640 cm⁻¹ and 810 cm⁻¹, and at an N—H characteristic peak location 1550 cm⁻¹, indicating that C═C and N—H exist in a molecular structure of the polyurethane B.

### Embodiment 3

### Preparation of a Low-Molecular-Weight Polyurethane Acrylate C (Weight-Average Molecular Weight 1338):

Put a 100 ppm catalyst (relative to 1gAOI) and a 200 ppm antioxidant (relative to 1gAOI) into a beaker, and then add polycarbonate diol (synthesized using by 2-methyl-2,4-pentadiol (MPD) and terephthalic acid as raw materials, a number-average molecular weight Mn=641, and a weight-average molecular weight Mw=1051) into the beaker. After a temperature rises to 80° C., add dropwise an isocyanate ethyl acrylate (AOI) monomer to a polyol until a chemical measurement ratio of a hydroxy group to an isocyanate group is 1.05-1.2:1. After 4-12 hours of mixing and reacting, prepare the low-molecular-weight polyurethane acrylate C (polyurethane C for short), where a weight-average molecular weight Mw of the obtained polyurethane C is 1338, a number-average molecular weight Mn is 936, viscosity is 80610, and a PDI is 1.43.

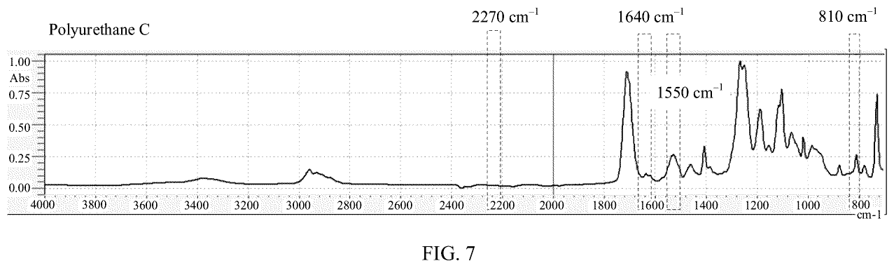

FIG. 7 is a representation diagram of an infrared spectrum of the polyurethane C prepared according to Embodiment 3 of this disclosure. It can be learned from FIG. 7 that there is no peak at a characteristic peak location 2270 cm⁻¹ of the isocyanate group-NCO, indicating that isocyanate group reaction is complete. In addition, there are obvious peaks at C═C characteristic peak locations 1640 cm⁻¹ and 810 cm⁻¹ and at an N—H characteristic peak location 1550 cm⁻¹, indicating that C═C and N—H exist in a molecular structure of the polyurethane C.

### Embodiment 4

### Preparation of a Low-Molecular-Weight Polyurethane Acrylate D (Weight-Average Molecular Weight 560):

Put a 100 ppm catalyst (relative to 1gAOI) and a 200 ppm antioxidant (relative to 1gAOI) into a beaker, and then add a polytetramethylene ether glycol (PTMEG, a number-average molecular weight Mn=340, and a weight-average molecular weight Mw=425) into the beaker. After a temperature rises to 80° C., add dropwise an isocyanate ethyl acrylate (AOI) monomer to a polyol until a chemical measurement ratio of a hydroxy group to an isocyanate group is 1.05-1.2:1. After 4-12 hours of mixing and reacting, prepare the low-molecular-weight polyurethane acrylate D (polyurethane D for short), where a weight-average molecular weight Mw of the obtained polyurethane D is 560, a number-average molecular weight Mn is 445, viscosity is 7800, and a PDI is 1.26.

### Embodiment 5

### Preparation of a Low-Molecular-Weight Polyurethane Acrylate E (Weight-Average Molecular Weight 4860):

Put a 100 ppm catalyst (relative to 1gAOI) and a 200 ppm antioxidant (relative to 1gAOI) in a beaker, and then add polycaprolactone glycol (PCL, a number-average molecular weight Mn=3340, a weight-average molecular weight Mw=4560) into the beaker. After a temperature rises to 80° C., add dropwise an isocyanate ethyl acrylate (AOI) monomer to a polyol until a chemical measurement ratio of a hydroxy group to an isocyanate group is 1.05-1.2:1. After 4-12 hours of mixing and reacting, prepare the low-molecular-weight polyurethane acrylate E (polyurethane E for short), where a weight-average molecular weight Mw of the obtained polyurethane E is 4860, a number-average molecular weight Mn is 3578, viscosity is 56000, and a PDI is 1.36.

Parameters in Embodiments 1-5 are listed in Table 1.

TABLE 1
Parameter summary table of Embodiments 1-5

| | | | | Number- | Weight- | |
|---|---|---|---|---|---|---|
| | | | | average | average | |
| | | | Viscosity | molecular | molecular | |
| | | Isocyanate | (centipoise | weight | weight | |
| Embodiment | Polyol type | acrylate | cp) | Mn | Mw | PDI |
| Embodiment | Polycarbonate diol | AOI | 3600 | 683 | 1344 | 1.97 |
| 1 | (MPD/1,6-HD/DEC, | | | | | |
| Polyurethane | Mn = 557, Mw = 1293) | | | | | |
| A | | | | | | |
| Embodiment | Polycarbonate diol | AOI | 27840 | 1340 | 2503 | 1.87 |
| 2 | (MPD/1,6-HD/DEC, | | | | | |
| Polyurethane | Mn = 1083, Mw = 2313) | | | | | |
| B | | | | | | |
| Embodiment | Polyester diol | AOI | 80610 | 936 | 1338 | 1.43 |
| 3 | (MPD/Terephthalic acid, | | | | | |
| Polyurethane | Mn = 641, Mw = 1051) | | | | | |
| C | | | | | | |
| Embodiment | Polytetramethylene ether | AOI | 7800 | 445 | 560 | 1.26 |
| 4 | glycol | | | | | |
| Polyurethane | (PTMG, Mn = 340, | | | | | |
| D | Mw = 425) | | | | | |
| Embodiment | Polycaprolactone glycol | AOI | 56000 | 3578 | 4860 | 1.36 |
| 5 | (PCL, Mn = 3340, | | | | | |
| Polyurethane | Mw = 4560) | | | | | |
| E | | | | | | |

It can be learned from Table 1 that, in Embodiment 1 to Embodiment 5 of this disclosure, a polyurethane acrylate with a low molecular weight, suitable viscosity, and narrow molecular weight distribution is prepared by using a polyol and an isocyanate ethyl acrylate based on a one-step method, and a process is simple and efficient, so that industrial production can be implemented.

### Embodiment 6

### Preparation of a Resin Composition 1 (the Polyurethane A is Selected):

The low-molecular-weight polyurethane A synthesized in the foregoing embodiment, a UV moisture curing monomer (a molecular weight is 600) in the formula (1), a photoinitiator A (α-hydroxy ketone), a photoinitiator B (acylphosphine oxide), and a thiol A (pentaerythritol tetrakis(3-mercaptobutyric acid) ester) are mixed at a mass ratio 80:20:0.5:0.5:0.5, and then defoamed after being loaded into a rubber tube, to obtain the resin composition 1, that is, to obtain a low volatile adhesive.

A proportion of a non-volatile component before the resin composition 1 is cured is 99.36%; a proportion of the non-volatile component after the resin composition 1 is cured is 98.70%; and a shear strength is 1.25 Mpa.

### Embodiment 7

### Preparation of a Resin Composition 2 (the Polyurethane a is Selected):

The low-molecular-weight polyurethane A synthesized in the foregoing embodiment, a UV moisture curing monomer (a molecular weight is approximately 520) in the formula (2), the photoinitiator A (α-hydroxy ketone), the photoinitiator B (acylphosphine oxide), and the thiol A (pentaerythritol tetrakis(3-mercaptobutyric acid) ester) are mixed at a mass ratio 80:20:0.5:0.5:0.5, and then defoamed after being loaded into the rubber tube, to obtain the resin composition 2, that is, to obtain a low volatile adhesive.

A proportion of a non-volatile component before the resin composition 2 is cured is 99.20%; a proportion of the non-volatile component after the resin composition 2 is cured is 98.50%; and a shear strength is 1.21 Mpa.

### Embodiment 8

### Preparation of a Resin Composition 3 (Two Polyurethane Acrylates of the Polyurethane A and the Polyurethane B are Selected for Mixing):

The low-molecular-weight polyurethane A and polyurethane B synthesized in the foregoing embodiment, the UV moisture curing monomer (the molecular weight 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 40:40:20:0.5:0.5:0.5, and then defoamed after being loaded into the rubber tube, to obtain the resin composition 3, that is, to obtain a low volatile adhesive.

A proportion of a non-volatile component before the resin composition 3 is cured is 99.45%; a proportion of the non-volatile component after the resin composition 3 is cured is 99.29%; and a shear strength is 1.23 Mpa.

### Embodiment 9

Preparation of a Resin Composition 4 (without Adding a Thiol):

The low-molecular-weight polyurethane A synthesized in the foregoing embodiment, the UV moisture curing monomer (the molecular weight is 600) in the formula (1), the photoinitiator A (α-hydroxy ketone), and the photoinitiator B (acylphosphine oxide) are mixed at a mass ratio 80:20:0.5:0.5, and then defoamed after being loaded into the rubber tube, to obtain the resin composition 4, that is, to obtain a low volatile adhesive.

A proportion of a non-volatile component before the resin composition 4 is cured is 99.17%; a proportion of the non-volatile component after the resin composition 4 is cured is 98.93%; and a shear strength is 1.19 Mpa.

### Embodiment 10

Preparation of a Resin Composition 5 (Addition of the Thiol is Doubled Compared with that of the Composition 1):

The low-molecular-weight polyurethane A synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 80:20:0.5:0.5, and then defoamed after being loaded into the rubber tube, to obtain the resin composition 5, that is, to obtain a low volatile adhesive.

A proportion of a non-volatile component before the resin composition 5 is cured is 99.40%; a proportion of the non-volatile component after the resin composition 5 is cured is 98.82%; and a shear strength is 1.35 Mpa.

### Embodiment 11

### Preparation of a Resin Composition 6 (the Polyurethane C is Selected):

The low-molecular-weight polyurethane C synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 80:20:0.5:0.5:0.5, and then defoamed after being loaded into the rubber tube, to obtain the resin composition 6, that is, to obtain a low volatile adhesive.

A proportion of a non-volatile component before the resin composition 6 is cured is 99.65%; a proportion of the non-volatile component after the resin composition 6 is cured is 99.48%; and a shear strength is 1.05 Mpa.

### Embodiment 12

### Preparation of a Resin Composition 7 (the Polyurethane D is Selected):

The low-molecular-weight polyurethane D synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 80:20:0.5:0.5:0.5, and then defoamed after being loaded into the rubber tube, to obtain the resin composition 7, that is, to obtain a low volatile adhesive.

A proportion of a non-volatile component before the resin composition 7 is cured is 99.10%; a proportion of the non-volatile component after the resin composition 7 is cured is 98.90%; and a shear strength is 1.05 Mpa.

### Embodiment 13

### Preparation of a Resin Composition 8 (the Polyurethane E is Selected):

The low-molecular-weight polyurethane D synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 80:20:0.5:0.5:0.5, and then defoamed after being loaded into the rubber tube, to obtain the resin composition 8, that is, to obtain a low volatile adhesive.

A proportion of a non-volatile component before the resin composition 8 is cured is 99.61%; a proportion of the non-volatile component after the resin composition 8 is cured is 98.48%; and a shear strength is 1.2 Mpa.

### Embodiment 14

### Preparation of a Resin Composition 9 (Two Polyurethane Acrylates of the Polyurethane A and the Polyurethane C are Selected for Mixing):

The low-molecular-weight polyurethane A and polyurethane C synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 40:40:20:0.5:0.5:0.5, and then defoamed after being loaded into the rubber tube, to obtain the resin composition 9, that is, to obtain a low volatile adhesive.

A proportion of a non-volatile component before the resin composition 9 is cured is 99.49%; a proportion of the non-volatile component after the resin composition 9 is cured is 99.14%; and a shear strength is 1.63 Mpa.

### Embodiment 15

### Preparation of a Resin Composition 10:

The low-molecular-weight polyurethane A and polyurethane C synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 40:40:20:0.5:0.5:1, and then defoamed after being loaded into the rubber tube, to obtain the resin composition 10, that is, to obtain a low volatile adhesive.

A proportion of a non-volatile component before the resin composition 10 is cured is 99.30%; a proportion of the non-volatile component after the resin composition 10 is cured is 99.62%; and a shear strength is 1.98 Mpa.

### Embodiment 16

### Preparation of a Resin Composition 11:

The low-molecular-weight polyurethane A and polyurethane C synthesized in the foregoing embodiment, the UV moisture curing monomer (the molecular weight is 600) in the formular (1), the photoinitiator A (α-hydroxy ketone), the photoinitiator B (acylphosphine oxide), and a thiol B (pentaerythritol tetrakis(3-mercaptopropionic acid) ester) are mixed at a mass ratio 40:40:20:0.5:0.5:0.5, and then defoamed after being loaded into the rubber tube, to obtain the resin composition 11, that is, to obtain a low volatile adhesive.

A proportion of a non-volatile component before the resin composition 11 is cured is 99.60%; a proportion of the non-volatile component after the resin composition 11 is cured is 99.19%; and a shear strength is 2.18 Mpa.

### Embodiment 17

### Preparation of a Resin Composition 12:

The low-molecular-weight polyurethane A and polyurethane C synthesized in the foregoing embodiment, the UV moisture curing monomer (the molecular weight is 600), the photoinitiator A (α-hydroxy ketone), the photoinitiator B (acylphosphine oxide), and the thiol B (pentaerythritol tetrakis(3-mercaptopropionic acid) ester) are mixed at a mass ratio 40:40:20:0.5:0.5:1, and then defoamed after being loaded into the rubber tube, to obtain the resin composition 12, that is, to obtain a low volatile adhesive.

A proportion of a non-volatile component before the resin composition 12 is cured is 99.53%; a proportion of the non-volatile component after the resin composition 12 is cured is 98.96%; and a shear strength is 2.34 Mpa.

### Embodiment 18

### Preparation of a Resin Composition 13:

The low-molecular-weight polyurethane A synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 180:20:0.5:0.5:0.5, and then defoamed after being loaded into the rubber tube, to obtain the resin composition 13, that is, to obtain a low volatile adhesive.

A proportion of a non-volatile component before the resin composition 13 is cured is 99.18%; a proportion of the non-volatile component after the resin composition 13 is cured is 99.50%; and a shear strength is 1.17 Mpa.

### Embodiment 19

### Preparation of a Resin Composition 14:

The low-molecular-weight polyurethane A synthesized in the foregoing embodiment, the UV moisture curing monomer (the molecular weight is 600) in the formula (1), the photoinitiator A (α-hydroxy ketone), the photoinitiator B (acylphosphine oxide), and the thiol A (pentaerythritol tetrakis(3-mercaptobutyric acid) ester) are mixed at a mass ratio 50:40:0.5:0.5:0.5, and then defoamed after being loaded into the rubber tube, to obtain the resin composition 14, that is, to obtain a low volatile adhesive.

A proportion of a non-volatile component before the resin composition 14 is cured is 99.40%; a proportion of the non-volatile component after the resin composition 14 is cured is 99.05%; and a shear strength is 1.06 Mpa.

### Comparative Example 1

The low-molecular-weight polyurethane A synthesized in Embodiment 1 of this disclosure, an isobornyl acrylate (IBOA, a UV curing monomer with a molecular weight 208), the photoinitiator A (α-hydroxy ketone), and the photoinitiator B (acylphosphine oxide) are mixed at a mass ratio 80:20:0.5:0.5, and then defoamed after being loaded into the rubber tube, to obtain a resin composition of the comparative example 1.

### Comparative Example 2

Put a 100 ppm catalyst (relative to 1 g IPDI) into a beaker, and then add polyester diol (synthesized by an adipic acid (AA) and 2-methyl-2,4-pentadiol (MPD) as raw materials, a number-average molecular weight Mn=1890, and a weight-average molecular weight Mw=2850) and an isobornyl acrylate (IBOA) monomer into the beaker and perform dilution. After a temperature rises to 80° C., add dropwise isofolone diisocyanate (IPDI) to a polyol until a chemical measurement ratio of a hydroxy group to an isocyanate group is 1:1.2-1.4. After 4-12 hours of mixing and reacting, a high-molecular-weight polyurethane acrylate F (polyurethane F for short) is prepared, through end-capping, by adding a hydroxyethyl acrylate (HEA), and a weight-average molecular weight Mw of the polyurethane F is 34000, a number-average molecular weight Mn is 17282, viscosity is 25000, and a PDI is 1.97. The prepared polyurethane acrylate F with the weight-average molecular weight 34000, the isobornyl acrylate (IBOA, a UV curing monomer with a molecular weight 208), the photoinitiator A (α-hydroxy ketone), and the photoinitiator B (acylphosphine oxide) are mixed at a mass ratio 52:48:0.5:0.5, and then defoamed after being loaded into the rubber tube, to obtain a resin composition of the comparative example 2.

In this disclosure, refer to FIG. 4. A method for testing a shear strength is as follows: a standard glass sample with a size 100 mm×25.4 mm×2.5 mm and a polybutylene terephthalate (PBT) sample are used, the glass sample and the PBT sample are bonded by using adhesive samples in this disclosure, and a bonding surface is 12.7 mm×25.4 mm; a spacer of 0.12 mm is used to control a thickness of an adhesive layer, and the sample is cleaned by using an anhydrous ethanol before bonding; and 365 nm UV light of 6000 mj/cm² is used to perform a universal tensile machine test, stretching is performed along a length direction of the sample, and a test speed is 10 mm/min. In addition, in the embodiment and the comparative example, the mass proportion of the non-volatile component before and after the resin composition is light cured is determined according to a method of the GB/T 2793-1995 “Measurement of Non-volatile Substance Content of Adhesive”. A specific test temperature is 150° C. and test duration is 30 min.

Data values of Embodiments 6-12 are listed in Table 2, and data values of Embodiments 13-19 and the comparative examples are listed in Table 3.

TABLE 2
Summary table of experimental data of Embodiments 6-12

| Mass fraction | | | | | | | |
|---|---|---|---|---|---|---|---|
| of components/ | | | | | | | |
| representation | Resin | Resin | Resin | Resin | Resin | Resin | Resin |
| parameter | composition 1 | composition 2 | composition 3 | composition 4 | composition 5 | composition 6 | composition 7 |
| Polyurethane | 80 | 80 | 40 | 80 | 80 | — | — |
| A | | | | | | | |
| Polyurethane | — | — | 40 | — | — | — | — |
| B | | | | | | | |
| Polyurethane | — | — | — | — | — | 80 | — |
| C | | | | | | | |
| Polyurethane | — | — | — | — | — | — | 80 |
| D | | | | | | | |
| Polyurethane | — | — | — | — | — | — | — |
| E | | | | | | | |
| Polyurethane | — | — | — | — | — | — | — |
| F | | | | | | | |
| Curing | 600 | 520 | 600 | 600 | 600 | 600 | 600 |
| monomer | | | | | | | |
| molecular | | | | | | | |
| weight | | | | | | | |
| Curing | 20 | 20 | 20 | 20 | 20 | 20 | 20 |
| monomer | | | | | | | |
| Photoinitiator | 0.5 | 0.5 | 0.5 | 0.5 | 0.5 | 0.5 | 0.5 |
| A | | | | | | | |
| Photoinitiator | 0.5 | 0.5 | 0.5 | 0.5 | 0.5 | 0.5 | 0.5 |
| B | | | | | | | |
| Thiol A | 0.5 | 0.5 | 0.5 | — | 1 | 0.5 | 0.5 |
| Thiol B | — | — | — | — | — | — | — |
| Viscosity (cp) | 5259 | 5323 | 5459 | 4619 | 4020 | 54500 | 12000 |
| Mass | 99.36 | 99.20 | 99.45 | 99.17 | 99.40 | 99.65 | 99.10 |
| proportion % | | | | | | | |
| of a non- | | | | | | | |
| volatile | | | | | | | |
| component | | | | | | | |
| before curing | | | | | | | |
| is performed | | | | | | | |
| Mass | 98.70 | 98.50 | 99.29 | 98.93 | 98.82 | 99.48 | 98.90 |
| proportion % | | | | | | | |
| of a non- | | | | | | | |
| volatile | | | | | | | |
| component | | | | | | | |
| after curing is | | | | | | | |
| performed | | | | | | | |
| Shear | 1.25 | 1.21 | 1.23 | 1.19 | 1.35 | 1.05 | 1.05 |
| strength | | | | | | | |
| (Mpa) | | | | | | | |

TABLE 3
Summary table of experimental data of Embodiments 13-19

| Mass fraction | | | | | | | | | |
|---|---|---|---|---|---|---|---|---|---|
| of components/ | Resin | Resin | Resin | Resin | Resin | Resin | Resin | Comparative | Comparative |
| representation | composition | composition | composition | composition | composition | composition | composition | example | example |
| parameter | 8 | 9 | 10 | 11 | 12 | 13 | 14 | 1 | 2 |
| Polyurethane A | — | 40 | 40 | 40 | 40 | 180 | 50 | 80 | — |
| Polyurethane B | — | — | — | — | — | — | — | — | — |
| Polyurethane C | — | 40 | 40 | 40 | 40 | — | — | — | — |
| Polyurethane D | — | — | — | — | — | — | — | — | — |
| Polyurethane E | 80 | — | — | — | — | — | — | — | — |
| Polyurethane F | — | — | — | — | — | — | — | — | 52 |
| Curing | 600 | 600 | 600 | 600 | 600 | 600 | 600 | 208 | 208 |
| monomer | | | | | | | | | |
| molecular | | | | | | | | | |
| weight | | | | | | | | | |
| Curing | 20 | 20 | 20 | 20 | 20 | 20 | 40 | 20 | 48 |
| monomer | | | | | | | | | |
| Photoinitiator A | 0.5 | 0.5 | 0.5 | 0.5 | 0.5 | 0.5 | 0.5 | 0.5 | 0.5 |
| Photoinitiator B | 0.5 | 0.5 | 0.5 | 0.5 | 0.5 | 0.5 | 0.5 | 0.5 | 0.5 |
| Thiol A | 0.5 | 0.5 | 1 | — | — | 0.5 | 0.5 | — | — |
| Thiol B | — | — | — | 0.5 | 1 | — | — | — | — |
| Viscosity | 23400 | 20400 | 9659 | 8639 | 7739 | 5579 | 5039 | 2640 | 57470 |
| Mass | 99.61 | 99.49 | 99.30 | 99.60 | 99.53 | 99.18 | 99.40 | 74.31 | 67.11 |
| proportion % of | | | | | | | | | |
| a non-volatile | | | | | | | | | |
| component | | | | | | | | | |
| before curing is | | | | | | | | | |
| performed | | | | | | | | | |
| Mass | 99.48 | 99.14 | 99.62 | 99.19 | 98.96 | 99.50 | 99.05 | 96.70 | 91.99 |
| proportion % of | | | | | | | | | |
| a non-volatile | | | | | | | | | |
| component after | | | | | | | | | |
| curing is | | | | | | | | | |
| performed | | | | | | | | | |
| Shear strength | 1.2 | 1.63 | 1.98 | 2.18 | 2.34 | 1.17 | 1.06 | 1.33 | 2.19 |
| (Mpa) | | | | | | | | | |

It can be learned from the results of Table 2 and Table 3 that, in embodiments of this disclosure, mass proportions of non-volatile components before and after the resin composition is cured are higher than mass proportions of non-volatile components before and after the resin composition in the comparative examples is cured, and are higher than 98.5%. This indicates that VOC content is low before and after the resin composition is cured in embodiments of this disclosure, and an allergy risk is low. Therefore, when the resin composition in embodiments of this disclosure is used in a wearable device such as a headset, a human allergy risk can be reduced, which improves product competitiveness and user experience. It can be further learned from the results in Table 2 and Table 3 that the resin composition in embodiments of this disclosure has a high shear strength, and the shear strength is greater than 1 MPa, so that good bonding effect can be obtained. The resin composition in embodiments of this disclosure has good bonding effect, low VOC content, and a low allergy risk, and may be used for assembling and fastening an element of a wearable device. In addition, in comparison with the resin composition 1, the resin composition 4, and the resin composition 5, the addition of the thiol can improve curing performance of the resin composition and improve the shear strength. In comparison with the resin composition 9, the resin composition 10, the resin composition 11, and the resin composition 12, it can be seen that an increase in the addition of thiol to some extent helps improve curing performance. In comparison with the resin composition 9, the resin composition 10, the resin composition 11, and the resin composition 12, it can be further seen that the thiol B is more conducive to improving the resin curing performance than the thiol A, but the inventor finds that storage stability of the resin composition 11 and the resin composition 12 is lower than that of the resin composition 9 and the resin composition 10.

The resin composition 1, the resin composition 9, and the resin composition 10 obtained in embodiments are tested for hardness, elongation at break, and tensile strength after being cured, and measured results are listed in Table 4.

A Shore hardness measurement manner is as follows: make a resin composition into a 3 mm thick wafer, and use a Shore hardness meter to measure hardness. The elongation at break and tensile strength are as follows: the resin composition is prepared into a film with a thickness 0.2 mm and is measured according to ASTM D638, the elongation at break indicates a ratio of a displacement value of a sample to an original length when the sample is broken, and is represented by percentage (%); and the tensile strength represents a maximum resistance of a material to uniform plastic deformation.

The resin composition 1, the resin composition 9, and the resin composition 10 obtained in embodiments are measured in shear strength before and after curing is performed. The shear strength after curing is performed includes an initial shear strength after curing is performed by using 365 nm UV light of 6000 mj/cm², a shear strength after seven days (7×24 hours) at a room temperature after light curing is performed, and a shear strength after curing is performed at a pure moisture room temperature for two days (2×24 hours). The measured results are listed in Table 4.

TABLE 4
Performance test results of resin compositions

| | | | | Glass/PBT (shear strength MPa) | | |
|---|---|---|---|---|---|---|
| | | | | UV 365 nm | | Pure |
| | | | | 6000 mj/cm² | | moisture |
| | | | Tensile | | After seven | room |
| Resin | Shore | Elongation | strength | | days at a room | temperature |
| composition | hardness | at break | (MPa) | Initial | temperature | for two days |
| Resin | 45 | 136% | 10.9 | 1.25 | 1.62 | 2.1 |
| composition | | | | | | |
| 1 | | | | | | |
| Resin | 60 | 144% | 27.9 | 1.63 | 2.01 | 2.87 |
| composition | | | | | | |
| 9 | | | | | | |
| Resin | 65 | 148% | 15.0 | 1.98 | 2.34 | 2.5 |
| composition | | | | | | |
| 10 | | | | | | |

It can be learned from the result in Table 4 that the resin composition in embodiments of this disclosure can obtain features such as hardness, elongation at break, tensile strength, and shear strength that can meet requirements of a conventional adhesive product. It can also be learned from the result in Table 4 that the resin composition in embodiments of this disclosure has a UV light/moisture double curing characteristic, and moisture curing can compensate for incomplete light curing.

A GC-MS (gas chromatograph-mass spectrometer) is used to measure content of a volatile substance before and after the resin composition is cured, a thermal weight loss method is used to measure content of a non-volatile substance before and after the resin composition is cured (a test temperature is 150° C./test duration is 30 min), and then the content of the non-volatile substance is converted into the content of the volatile substance. Measured results of the resin composition 1, the resin composition 9, the resin composition 10, and the resin composition 2 in embodiments of this disclosure are listed in Table 5.

TABLE 5
Measured results of content of volatile substances
before and after resin compositions are cured

| | Test method | | | | | | |
|---|---|---|---|---|---|---|---|
| | | | | GB/T 2793-1995 | | | |
| | | | | Measurement of content of a non- | | | |
| | | | | volatile substance of an adhesive | | | |
| | | | | Content of a volatile substance | | | |
| | GB 33372-2020 | | | (150° C./30 min) | | | |
| | Volatile organic compound | | | | | After pure | |
| | limit of an adhesive | | | | | moisture | |
| | VOC content (GC-MS) | | | | | curing for | |
| | | UV | After pure | | UV | two days at | |
| | Before | After | moisture | Before | After | a room | Odor after |
| Resin | curing | curing | curing | curing | curing | temperature | curing is |
| composition | (mg/g) | (mg/g) | (mg/g) | (mg/g) | (mg/g) | (mg/g) | performed |
| Resin | 18.9 | 10.1 | 17.7 | 6.4 | 13.0 | 8.4 | No odor |
| composition | | | | | | | |
| 1 | | | | | | | |
| Resin | 15.7 | 11.0 | 14.0 | 5.1 | 8.6 | 8.5 | No odor |
| composition | | | | | | | |
| 9 | | | | | | | |
| Resin | 17.6 | 14.8 | 17.3 | 7.0 | 3.8 | 8.5 | No odor |
| composition | | | | | | | |
| 10 | | | | | | | |
| Comparative | 240.0 | 23.8 | 33.2 | 328.9 | 80.1 | 165.0 | Faint odor |
| example 2 | | | | | | | |

It can be learned from the measured result in Table 5 that, in embodiments of this disclosure, content of a volatile substance before the resin composition is cured is far lower than content of a volatile substance before the resin composition is cured in the comparative example 2. In embodiments of this disclosure, content of volatile substances after the resin composition is UV light cured and pure moisture cured is lower than content of volatile substances after the resin composition is UV light cured and pure moisture cured in the comparative example 2. In addition, because the content of the volatile substance after the resin composition in the comparative example 2 is cured is high and a faint odor is emitted, and the content of the volatile substance after the resin composition in embodiments of this disclosure is cured is low and has no odor, user experience of a terminal product using the resin composition of embodiments of this disclosure can be improved.

1. A resin composition, comprising:
a polyurethane acrylate; and
a curing monomer, wherein the curing monomer comprises at least one of a compound containing a free radical polymerizable group or a compound containing a moisture curable group, and a weight-average molecular weight of the curing monomer is greater than or equal to 300.

2. The resin composition according to claim 1, wherein the weight-average molecular weight of the curing monomer is greater than or equal to 500.

3. The resin composition according to claim 2, wherein the weight-average molecular weight of the curing monomer is 500-1000.

4. The resin composition according to claim 1, wherein a weight-average molecular weight of the polyurethane acrylate is greater than or equal to 500 and less than or equal to 5000.

5. The resin composition according to claim 1, wherein volatile Organic Compound (VOC) content before and after the resin composition is cured is less than 20 mg/g.

6. The resin composition according to claim 1, wherein weight content of a non-volatile substance before and after the resin composition is cured is greater than or equal to 98.5%.

7. The resin composition according to claim 1, wherein in the resin composition, mass proportions of the polyurethane acrylate and the curing monomer are respectively 50%-90% and 10%-50%.

8. The resin composition according to claim 1, wherein the resin composition further comprises a photoinitiator.

9. The resin composition according to claim 8, wherein in the resin composition, a mass proportion of the photoinitiator is 0.5%-5%.

10. The resin composition according to claim 1, wherein the resin composition further comprises a thiol.

11. The resin composition according to claim 10, wherein in the resin composition, a mass proportion of the thiol is less than or equal to 3%.

12. The resin composition according to claim 1, wherein the curing monomer comprises the compound containing at least one of the free radical polymerizable group or a compound containing an isocyanate-terminated group, or comprises the compound containing at least one of the free radical polymerizable group or a compound containing an alkoxysilyl group.

13. The resin composition according to claim 1, wherein the curing monomer comprises a compound represented by the following formula (1): 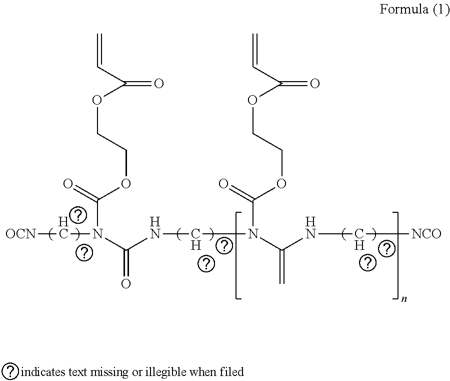
wherein in the formula (1), m and n are positive integers.

14. The resin composition according to claim 1, wherein the curing monomer comprises a compound represented by the following formula (2):

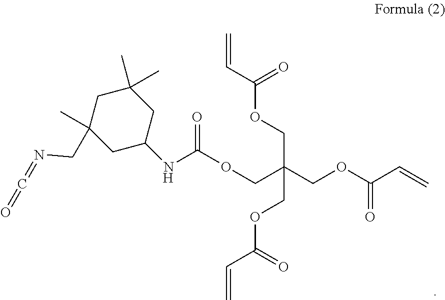

15. The resin composition according to claim 8, wherein the photoinitiator comprises one or more of an α-hydroxy ketone photoinitiator, an acylphosphine oxide photoinitiator, a benzyl formate photoinitiator, a benzil photoinitiator, a benzophenone photoinitiator, and an oxime ester photoinitiator.

16. The resin composition according to claim 10, wherein the thiol comprises one or more of pentaerythritol tetrakis(3-mercaptobutyric acid) ester, pentaerythritol tetrakis(3-mercaptopropionic acid) ester, tris[2-(3-mercaptopropionyloxy)ethyl] isocyanurate, and trimethylolpropane tris(3-mercaptopropionic acid ester).

17. The resin composition according to claim 1, wherein the polyurethane acrylate is prepared in the following manner:
under a condition that a catalyst and an antioxidant exist, mixing a polyol and an isocyanate ethyl acrylate monomer, and mixing and reacting for 4-12 hours at 40-100° C., to obtain the polyurethane acrylate.

18. The resin composition according to claim 1, wherein a shear strength of the resin composition is greater than or equal to 1 megapascal (Mpa).

19. A bonding structure, comprising:
a first bonding member,
a second bonding member, and
a bonding part disposed between the first bonding member and the second bonding member, and the bonding part comprises a curing product obtained by curing a resin composition, wherein the resin composition comprises:
a polyurethane acrylate; and
a curing monomer, wherein the curing monomer comprises at least one of a compound containing a free radical polymerizable group and/or a compound containing a moisture curable group, and a weight-average molecular weight of the curing monomer is greater than or equal to 300.

20. A device, wherein the device uses a resin composition, wherein the resin composition comprises:
a polyurethane acrylate; and
a curing monomer, wherein the curing monomer comprises at least one of a compound containing a free radical polymerizable group or a compound containing a moisture curable group, and a weight-average molecular weight of the curing monomer is greater than or equal to 300.
